(19) United States
(12) Patent Application Publication
(10) Pub. No.: US 2007/0290784 A1
(43) Pub. Date: Dec. 20, 2007

(54) Planar High Voltage Transformer Device

(76) Inventors: Arild Nesse, Sandnes (NO); Oyvind Wetteland, Stavanger (NO); Bjarte Kvingedal, Sandnes (NO)

Correspondence Address: PATTERSON & SHERIDAN, L.L.P., 3040 POST OAK BOULEVARD, SUITE 1500, HOUSTON, TX, 77056, US

(21) Appl. No.: 11/570,070

(22) PCT Filed: Jun. 3, 2005
(86) PCT No.: PCT/NO05/00185

§ 371 Date: Aug. 1, 2007

(30) Foreign Application Priority Data
Jun. 7, 2004 (NO) 20042346

(51) Int. Cl. H01F 27/28

(52) U.S. Cl. 336/232

(57) ABSTRACT

A planar transformer device comprising a primary coil (4), a secondary coil (6) and a core (8, 10), in which the coil layers (16, 24) of the secondary coil (6) are wound onto each other in a direction which is essentially parallel to the plane of the primary coil (4).

This invention relates to a planar high voltage transformer. More particularly, it concerns a planar high voltage transformer, in which the secondary coil of the transformer is designed essentially to overcome or to reduce, to a considerable degree, the known undesired electrical properties, such as parasitic capacitance, parasitic inductance and so-called skin effect and proximity effect.

For practical reasons and safety reasons, electrical energy is normally supplied to the consumer at a relatively low voltage. Whenever there is a need for high voltage electrical energy in the order of up to a few kilowatts (kW), it is common, locally, to transform up the supplied voltage to the desired voltage. For example, in the operation of electrostatic filters, power of from a few hundred watts up to several tens of kW may be involved with voltages of more than 10 kilovolts (kV).

According to the prior art, conventional high voltage transformers having a core of layered iron plates rich in silicon are used for transforming up the voltage. These high voltage transformers are suitable for use with a normal grid frequency, which is typically 50 or 60 Hertz (Hz).

High voltage transformers of this kind are relatively large and heavy. The main reason is that the iron core can only take a limited magnetic flux before reaching saturation. Thus, the cross-section of the iron core is decisive for how large a power the high voltage transformer is capable of delivering. As a consequence of the relatively large core, the windings of the high voltage transformer will be longer and thereby large. This causes the development of a considerable resistive power loss. The diameter of the winding wire must thereby be increased, which entails that the weight and dimension of the high voltage transformer are further increased.

The magnetic flux in a transformer core is given through the formula:

$$B = \frac{0 , 25 \cdot \hat{U}}{f \cdot N \cdot {A}_{e}}$$

in which B=magnetic flux in teslas, Û=peak driving voltage in volts, f=frequency in Hz and Aₑ=effective cross-section of the transformer core in m².

It appears from the formula that a magnetic flux in the transformer core is inversely proportional to the frequency.

On the basis of this fact, transformers with iron cores have been developed, which exhibit, by working at an elevated frequency, improved performance/efficiency relative to high voltage transformers working at mains frequency. The reason for the improved performance/efficiency is that the dimensions of the iron core may be reduced when the frequency is increased.

A method for supplying a relatively high frequency to the transformer includes a so-called SMPS (Switched Mode Power Supply) technique. According to this technique, the supplied power is transformed into a preferably square-pulsed high-frequency input voltage to the high voltage transformer.

A high voltage transformer of a known design has, due to its manner of operating, a relatively high number of turns in its secondary winding. This leads to an elevated secondary capacitance in that windings with many layers of a relatively thin winding wire will be spaced apart by a smaller average distance than those of a transformer in which the winding wire is of a larger diameter.

A relatively large secondary coil, large transformer core and necessary insulating gaps, in particular about the secondary coil, also result in high voltage transformers of this kind having a relatively high coupling inductance. The reason is that a relatively great distance between the primary and secondary windings results in poor magnetic coupling between them.

In the same way as the secondary capacitance and in combination with the secondary capacitance, this unintended and essentially inevitable parasitic coupling inductance will affect the current in the transformer. As the inductance reduces high-frequency current, it will reduce the current between the primary and secondary windings. High voltage transformers of this kind thus exhibit a relatively narrow band width, that is to say the highest driving frequency at which the high voltage transformer can operate.

SMPS is a well-known technique for achieving improved effectiveness in voltage transformation up to the order of 1 kV. With higher voltages it is necessary to adapt the transformer by means of techniques known in themselves, like voltage multiplication, high voltage transformers connected in series, layered winding technique or so-called resonant switching in order to compensate for a relatively narrow band width in a high voltage transformer.

Common to these techniques is, however, that they overcome the drawbacks only to a limited degree, while at the same time they complicate and thereby add to the cost of the complete high voltage transformer.

The so-called planar transformer is used to an increasing extent as a low voltage transformer. A planar transformer typically includes at least one printed circuit board, in which the windings have been etched into the copper layer of the circuit board, and in which, typically, a ferrite core encircles the windings. Due to the use of the planar shape winding of the circuit boards, ferrite cores of this kind are relatively low and elongate and are, therefore, referred to as planar cores.

The planar transformer exhibits favourable features by being easy to manufacture and having little parasitic coupling inductance because the windings are disposed relatively close together. Planar windings typically have a relatively low parasitic capacitance. This entails that the planar transformer generally exhibits a very good band width.

A high voltage planar transformer must be provided with a relatively high number of turns in the secondary winding. If all of this secondary winding is disposed in one circuit board, the area required for windings will be relatively large. Production-technical conditions restrict the size of a ferrite core. Therefore, it is necessary to divide the secondary winding into several layers, one on top of the other. Such a solution involves that a considerable parasitic secondary capacitance will arise, making impossible the use, for practical purposes, of planar transformers as high voltage transformers.

The invention has as its object to remedy or reduce at least one of the drawbacks of the prior art.

The object is achieved in accordance with the invention through the features specified in the description below and in the following Claims.

In order to use a planar transformer as a high voltage transformer at a typically high SMPS driving frequency, it is necessary to reduce the parasitic secondary capacitance to a considerable degree.

From known electrotheory it can be shown that the total capacitance between capacitances connected in series equals:
Cᵣ=1/(1/C₁+1/C₂+1/C₃+ . . . 1/Cₙ)

If all capacitances are equal, the formula is simplified into:
Cᵣ=C₁/N

If, for example, 40 conductors are placed in five layers, one above the other, with 8 conductors in each layer, and the total capacitance between each layer is 1 nF with ⅛ nF between each conductor located one opposite the other, the total capacitance will be:
C_{T}=¼ nF

However, if the same number of circuit board conductors are distributed into 20 layers of two conductors each, the capacitance between each layer is 2*⅛=¼ nF.

The total capacitance will be:
C_{T}=1/4/19 nF= 1/76 nF
or 19 times smaller than that of the four-layer example. In the example it has not been taken into account that the conductors of the two examples may be of different lengths.

A large number of circuit boards lying one on top of the other heightways, would be difficult to use in a planar transformer due to the lack of space.

The problem with the geometry in a planar transformer may be solved, as far as the secondary coil is concerned, by winding a relatively great number of layers, each having a small number of turns, into a narrow coil which is placed in the planar transformer in a plane parallel to the primary winding of the planar transformer. The relative number of layers in relation to the number of windings per layer is at least 1 and preferably more than 5.

Recognized methods of calculation of so-called skin effect and proximity effect, see P. L. Powel: “Effects of eddy currents in transformer windings” PROC. IEE, Vol. 113, No. 8, Aug. 1966, shows, however, that the number of layers significantly affects the so-called resistance factor, which is an undesired increase in the resistance of the winding at high driving frequencies. The resistance factor is affected and increased by the number of layers in square.

During testing of the invention it was surprisingly found that this theory is not applicable as far as the mentioned kind of secondary coils is concerned, and that, in spite of many layers, the proposed secondary coil design exhibits favourable values with respect to skin effect and proximity effect, and thereby a relatively low resistance factor.

In a preferred embodiment the secondary winding is formed as a relatively narrow roll of a conductor and intermediate insulating material, which is placed in a plane parallel to the primary winding of the planar transformer. This construction exhibits at least the same reduction in parasitic secondary capacitance as a narrow lying coil with few turns per layer.

The primary coil may be formed, for example, as at least one circuit board winding, a so-called Litz conductor winding or ordinary varnished wire, possibly combinations thereof. A Litz conductor typically comprises many individually insulated conductors.

By means of the device according to the invention the unfavourable electrical phenomena in a high voltage transformer are overcome or reduced, to a significant degree, so that the high voltage transformer can be made with a considerably improved band width relative to the prior art. The transformer is thus very suitable for so-called HV-SMPS (High Voltage Switched Mode Power Supply) operation.

As mentioned, in planar transformers it is common to use a ferrite core. However, if desirable, there may be used a core which is constructed from sheet metal or foil, and which is produced from a ferromagnetic material. Sheet metal cores are typically formed in an “E”-shape whereas, for production-technical reasons, foil cores are possibly made up of two “C”-shaped portions.

If it is desirable, for example, to have a relatively high coupling inductance, the primary and secondary windings can be spaced relatively wide apart in the core.

In the following is described a non-limiting example of a preferred embodiment, which is visualized in the accompanying drawings, in which:

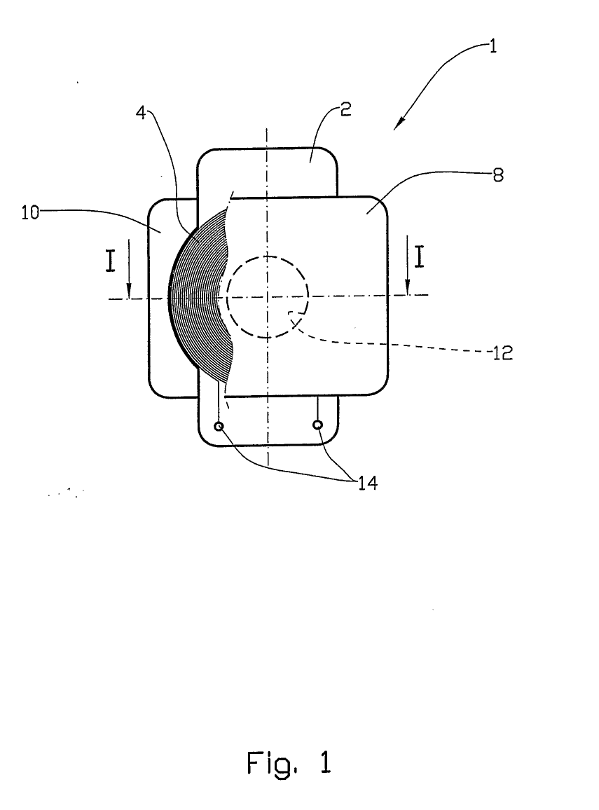

FIG. 1 shows a plan view of a planar transformer, partially in section;

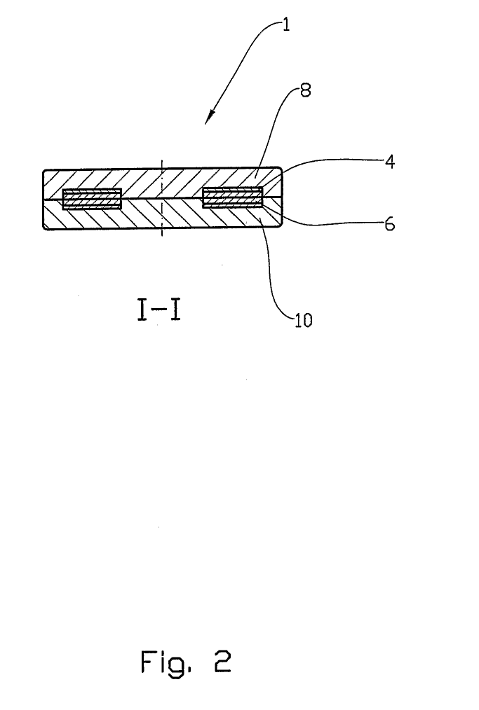

FIG. 2 shows a section I-I of FIG. 1;

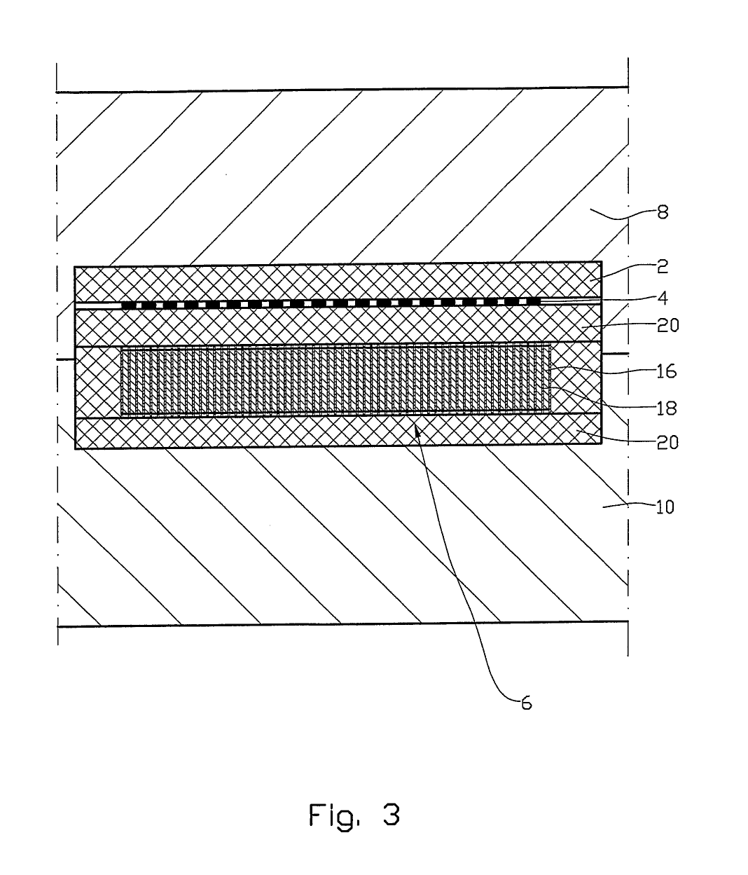

FIG. 3 shows on a larger scale a section from FIG. 2; and

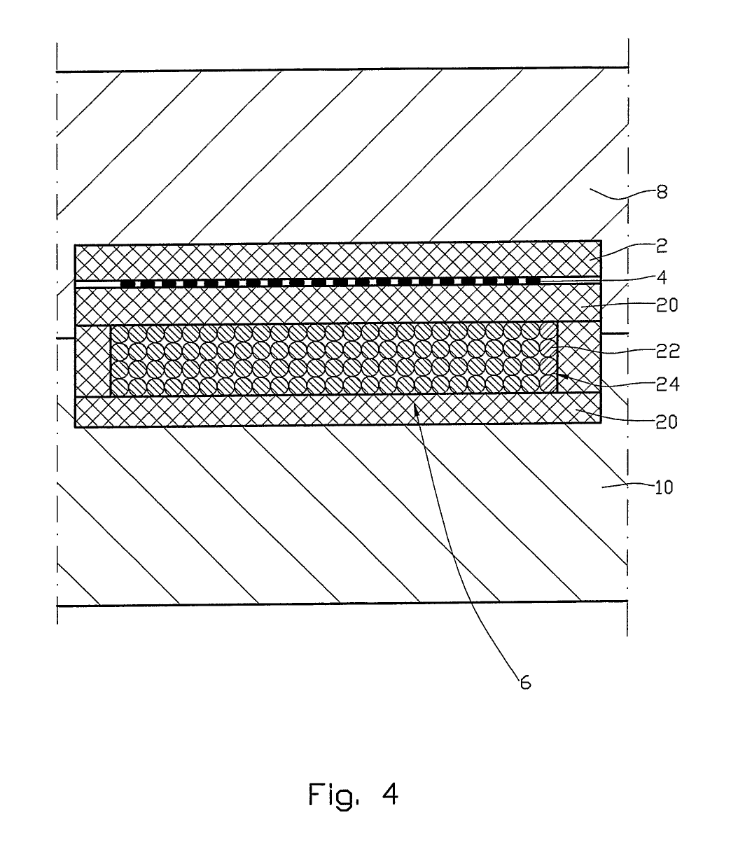

FIG. 4 shows an alternative embodiment.

In the drawings the reference numeral 1 identifies a high voltage planar transformer including a circuit board 2 having a primary coil 4, a secondary coil 6, an upper core half 8 and a lower core half 10.

The two E-shaped core halves 8 and 10 encircle the circuit board 2 and the coils 4 and 6 as the circuit board 2 is provided with a through central opening 12.

The circuit board 2 is further provided with two power supply connecting points 14 for the primary coil 4. The secondary coil 6 has two connecting points, not shown.

The secondary coil 6 is formed by a conductor 16 in the form of a coiled metal foil, preferably of copper, each layer of conductor foil 16 being insulated from an adjacent conductor foil layer 16 by means of insulating foil 18. The secondary coil 6 is further insulated from the primary coil 4 and the core halves 8, 10 by means of insulating material 20.

Each layer of conductor foil 16 forms a coil layer of the secondary coil 6.

The height of the secondary coil 6, that is to say the width of the copper foil 16, is substantially smaller, preferably less than one fifth of the width of the secondary coil 6 in the direction of winding.

The secondary coil 6 is disposed in such a manner that its direction of winding is essentially parallel to the plane of the primary coil 4.

As mentioned in the general part of the description, a relatively large number of conductor layers 16 contribute to make the secondary capacitance relatively small, whereas the compact construction characteristic of a planar transformer results in a substantial reduction in the coupling inductance of the high voltage transformer 1. Thereby, a high band width and the possibility of using a relatively high SMPS driving frequency are achieved.

In an alternative embodiment, see FIG. 4, the secondary coil 6 is formed by a varnish-insulated conductor/wire 22, possibly by a Litz conductor winding. The wire 22 is shown, in FIG. 4, to be wound in coil layers 24, each of four turns of wire 22, and in a relatively large number of layers 24. For illustrative reasons the coil layer 24 located the furthest in, is hatched in the opposite direction to the other coil layers 24. The coil layers 24 are wound onto each other and essentially in the same direction as the plane of the primary coil 4.

The ratio between the number of coil layers 24 and the number of conductors 22 in each coil layer 24 should exceed 5 in order that the proximity effect will not be too great.

This alternative embodiment does not exhibit as good results with respect to secondary capacitance as the embodiment in accordance with FIG. 3, but it is satisfactory for practical conditions.

1. A planar transformer device including a primary coil (4), a secondary coil (6) and a core (8, 10), characterized in that coil layers (16, 24) of the secondary coil (6) are wound onto each other in a direction which is essentially parallel to the plane of the primary coil (4).

2. A device in accordance with claim 1, characterized in that the primary coil (4) is formed by the copper sheet of a circuit board (2).

3. A device in accordance with claim 1, characterized in that the coil layer (16) of the secondary coil (6) is formed by metal foil.

4. A device in accordance with claim 1, characterized in that the coil layer of the secondary coil (6) is formed by an electrically insulated wire.

5. A device in accordance with claim 1, characterized in that the coil layer of the secondary coil (6) is formed by a Litz conductor.

6. A device in accordance with claim 1, characterized in that the core (8, 10) comprises an upper core half (8) and a lower core half (10).

7. A device in accordance with claim 1, characterized in that the core (8, 10) is made of a ferromagnetic material.
